(19) United States
(12) Patent Application Publication
(10) Pub. No.: US 2014/0223004 A1
(43) Pub. Date: Aug. 7, 2014

(54) NETWORK SYSTEM AND INFORMATION REPORTING METHOD

(71) Applicants: Tadashi HONDA, Kanagawa (JP); Tetsuharu Kohkaki, Kanagawa (JP); Kenta Yamano, Kanagawa (JP); Tomoya Amikura, Tokyo (JP); Masateru Kumagai, Kanagawa (JP); Yuuichiroh Hayashi, Kanagawa (JP)

(72) Inventors: Tadashi HONDA, Kanagawa (JP); Tetsuharu Kohkaki, Kanagawa (JP); Kenta Yamano, Kanagawa (JP); Tomoya Amikura, Tokyo (JP); Masateru Kumagai, Kanagawa (JP); Yuuichiroh Hayashi, Kanagawa (JP)

(21) Appl. No.: 14/172,138

(22) Filed: Feb. 4, 2014

(30) Foreign Application Priority Data
Feb. 6, 2013 (JP) 2013-021267
Jan. 17, 2014 (JP) 2014-007159

(51) Int. Cl. H04L 12/26

(52) U.S. Cl. CPC H04L 43/06
USPC 709/224

(57) ABSTRACT

A network system including one or more information processing devices includes plural information processing program executing units to execute different processes, and an execution control unit to cause, when receiving via a predefined interface, designation of one or more of the different processes and a reporting destination of a completion report indicating that the different processes have been executed from an application installed on an external device connected to the network system via a network, the information processing program executing units to execute the different processes based on the designation, and to transmit to the reporting destination, when the different processes executed by the information processing program executing units have been completed, a completion report indicating that the different processes have been completed.

### BACKGROUND OF THE INVENTION

1. Field of the Invention

The disclosures discussed herein relate to a network system and an information reporting method.

2. Description of the Related Art

There is a technology known in the art in which a print instruction is transmitted from a client to a server, and the server that has received the print instruction converts contents of print data subject to printing. In such a technology, the server provides a service to generate print data to a client.

Cloud computing, which has recently attracted much attention, is a form of providing services from a server to a client such as the one described above. In cloud computing, many computing resources are used for converting data, executing distributed data processing, and processing requests from a large number of clients. There are a large number of vendors that provide various services by implementing a web service in a cloud computing environment for realizing cloud computing as described above (see, for example, Patent Document 1).

For example, some data conversion or data processing executed by servers may take longer time to complete. The client who has requested the data conversion or data process will not be informed of the completion of the data conversion or data processing unless the client queries the server about it. The above circumstances may be observed between servers that collaborate on data (information) processing such as data conversion by executing distributed data processing, similar to the circumstances between a client and a server.

### RELATED ART DOCUMENTS

### Patent Document

Patent Document 1: Japanese Laid-Open Patent Publication No. 2012-226700

### SUMMARY OF THE INVENTION

It is a general object of at least one embodiment of the present invention to provide a network system, and an information reporting method that substantially obviate one or more problems caused by the limitations and disadvantages of the related art.

According to an aspect of the present invention, there is provided a network system including one or more information processing devices. The network system includes a plurality of information processing program executing units configured to execute different processes; and an execution control unit configured to cause, when receiving via a predefined interface, designation of one or more of the different processes and a reporting destination of a completion report indicating that the one or more of the different processes have been executed from an application installed on an external device connected to the network system via a network, one or more of the information processing program executing units to execute one or more of the different processes based on the designation of the one or more of the different processes, and to transmit to the reporting destination, when the one or more of the different processes executed by the one or more of the information processing program executing units have been completed, a completion report indicating that the one or more of the different processes have been completed.

The object and advantages of the invention will be realized and attained by means of the elements and combinations particularly pointed out in the claims.

It is to be understood that both the foregoing general description and the following detailed description are exemplary and explanatory and are not restrictive of the invention as claimed.

Other objects and further features of the present invention will be apparent from the following detailed description when read in conjunction with the accompanying drawings.

### BRIEF DESCRIPTION OF THE DRAWINGS

Other objects, features and advantages of the present invention will become more apparent from the following detailed description when read in conjunction with the accompanying drawings, in which:

FIG. 1 is a configuration diagram of an example of an information processing system according to a first embodiment;

FIG. 2 is a configuration diagram of another example of the service providing system;

FIG. 3 is a hardware configuration diagram of an example of a computer system;

FIG. 4 is a process block diagram of an example of a service providing system according to the first embodiment;

FIG. 5 is a configuration diagram of an example of organization information;

FIG. 6 is a configuration diagram of an example of user information;

FIG. 7 is a configuration diagram of an example of device information;

FIG. 8 is a schematic diagram depicting an example of a process of saving a scanned image in online storage;

FIG. 9 is a sequence diagram depicting an example of a process of saving a scanned image in the online storage;

FIG. 10 is a configuration diagram of an example of job information;

FIG. 11 is a configuration diagram of another example of the job information;

FIG. 12 is a configuration diagram (part 1 of 2) of an example of a job completion report;

FIG. 13 is a configuration diagram (part 2 of 2) of an example of the job completion report;

FIG. 14 is a diagram illustrating an example of an asynchronous process by a service providing system; and

FIG. 15 is a diagram illustrating a relationship between a queue, and a worker, and a worker framework.

### DETAILED DESCRIPTION OF THE PREFERRED EMBODIMENTS

A description is given, with reference to the accompanying drawings, of embodiments of the present invention.

### First Embodiment

### System Configuration

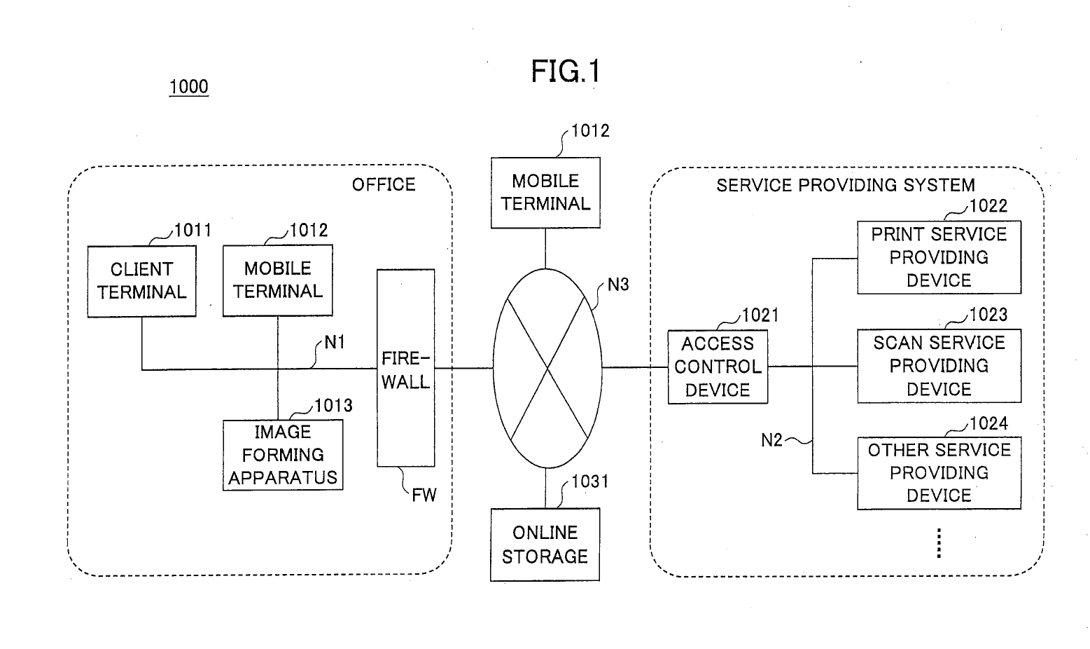

FIG. 1 is a configuration diagram of an example of an information processing system according to a first embodiment. An information processing system 1000 illustrated in FIG. 1 includes, for example, a network N1 such as a network in an office, a network N2 of a service providing system represented by a cloud service, and a network N3 such as the Internet. The network N1 is a private network behind a firewall FW. The firewall FW is installed at the contact point between the network N1 and the network N3, and detects and blocks unauthorized accesses. To the network N1, a client terminal 1011, a mobile terminal 1012, and an image forming apparatus 1013 such as a multifunction peripheral, are connected.

The client terminal 1011 is an example of a terminal device. The client terminal 1011 is realized by an information processing device in which a typical OS is installed. The client terminal 1011 includes a unit for performing radio communication or a unit for performing cable communication. The client terminal 1011 is a terminal that may be operated by a user, such as a tablet PC and a notebook PC.

The mobile terminal 1012 is an example of a terminal device. The mobile terminal 1012 includes a unit for performing radio communication or a unit for performing cable communication. The mobile terminal 1012 is a terminal that is portable for a user, such as a smartphone, a mobile phone, a tablet PC, and a notebook PC.

The image forming apparatus 1013 is a device having an image forming function, such as a multifunction peripheral. The image forming apparatus 1013 includes a unit for performing radio communication or a unit for performing cable communication. The image forming apparatus 1013 is a device for performing processes relevant to image forming, such as a multifunction peripheral, a copier, a scanner, a printer, a laser printer, a projector, and an electronic blackboard. FIG. 1 illustrates an example including one of each of the client terminal 1011, the mobile terminal 1012, and the image forming apparatus 1013; however, there may be a plurality of each of these devices.

The network N2 is connected to the network N3 by an access control device 1021. The security of the network N2 is protected by the access control device 1021. To the network N2, a print service providing device 1022, a scan service providing device 1023, and another service providing device 1024 are connected.

In the information processing system 1000 of FIG. 1, the access control device 1021, the print service providing device 1022, the scan service providing device 1023, and the other service providing device 1024 realize the service providing system. The print service providing device 1022, the scan service providing device 1023, and the other service providing device 1024 provide a print service, a scan service, and other services.

The access control device 1021 controls the operation of logging into a print service provided by the print service providing device 1022 and a scan service provided by the scan service providing device 1023.

The access control device 1021, the print service providing device 1022, the scan service providing device 1023, and the other service providing device 1024 are realized by one or more information processing devices.

The access control device 1021, the print service providing device 1022, the scan service providing device 1023, and the other service providing device 1024 may be realized by being integrated in a single information processing device, or may be realized by being distributed across a plurality of information processing devices.

Part of the services on the network N2 side may be outside the network N2. The mobile terminal 1012 may be outside the network N1 that is a network inside the office. In the example of the information processing system 1000 of FIG. 1, the mobile terminal 1012 is in the network N1 and in the network N3.

Online storage 1031 connected to the network N3 serves as a device configured to save files. The online storage 1031 may be a file saving device provided by vendors.

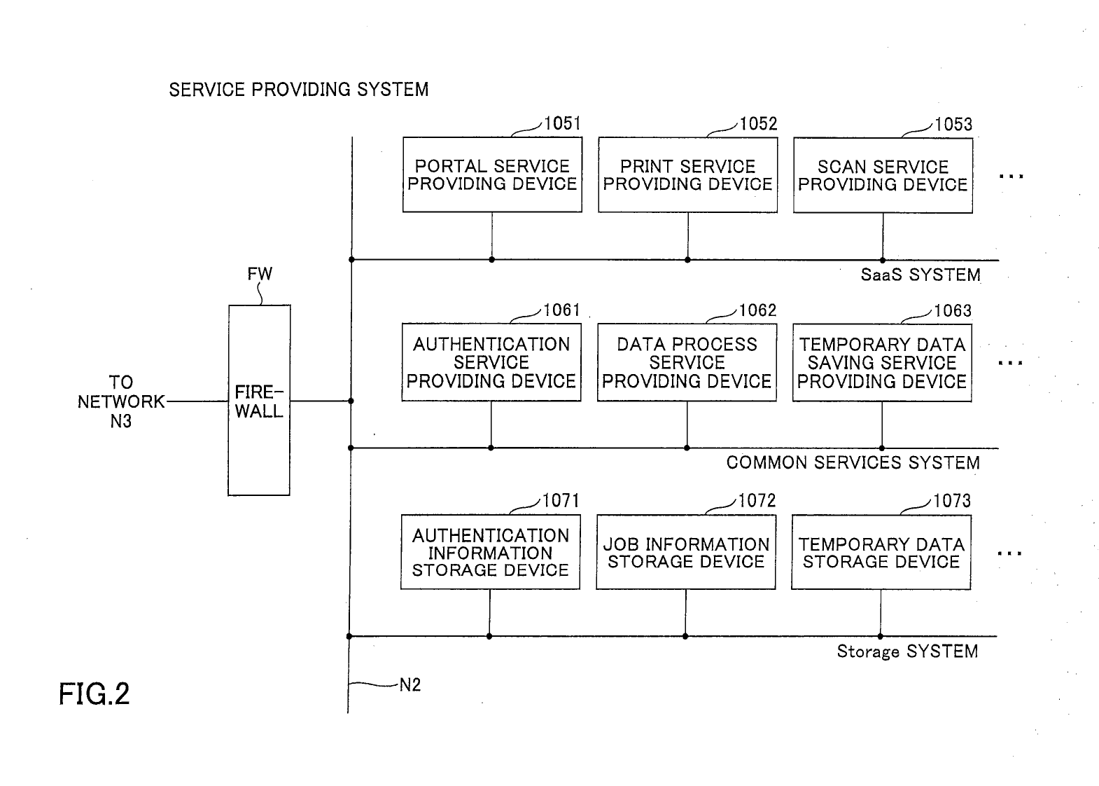

The configuration of the service providing system of FIG. 1 is one example; the service providing system may be realized by the configuration illustrated in FIG. 2. FIG. 2 is a configuration diagram of another example of the service providing system. In the service providing system of FIG. 2, the network N2 is connected to the network N3 by a firewall FW.

In the network N2, service providing devices of a SaaS (Software as a Service) system, service providing devices of a common service (Network Service Platform) system, and storage devices of a storage system are connected. The service providing device of a common service system provides a service that may be commonly used by the service providing devices of the SaaS system.

The service providing devices of the SaaS system include service providing devices according to the service to be provided, such as a portal service providing device 1051, a print service providing device 1052, and a scan service providing device 1053. Furthermore, the service providing devices of the common service system include service providing devices according to a common service to be provided, such as an authentication service providing device 1061, a data process service providing device 1062, and a temporary data saving service providing device 1063. The storage devices of the storage system include storage devices according to the information (data) to be stored, such as an authentication information storage device 1071, a job information storage device 1072, and a temporary data storage device 1073.

In the service providing system of FIG. 2, security is protected by authentication services provided by, for example, the firewall FW and the authentication service providing device 1061. Note that the configuration of the service providing system of FIG. 2 is also one example, and the service providing system may have other configurations.

### Hardware Configuration

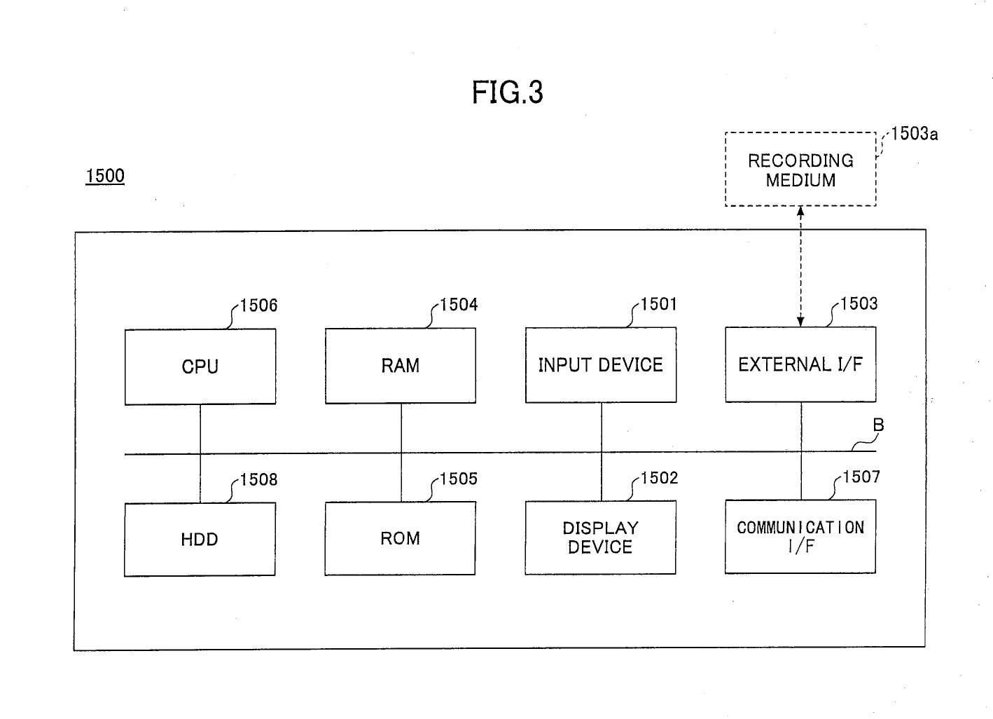

The client terminal 1011, the mobile terminal 1012, the access control device 1021, the print service providing device 1022, the scan service providing device 1023, and the other service providing device 1024 are realized by, for example, a computer system having a hardware configuration as illustrated in FIG. 3.

The service providing devices of the SaaS system, the service providing devices of the common service system, and the storage devices of the storage system illustrated in FIG. 2 may also be realized by, for example, a computer system having a hardware configuration as illustrated in FIG. 3.

FIG. 3 is a hardware configuration diagram of an example of a computer system. A computer system 1500 illustrated in FIG. 3 includes an input device 1501, a display device 1502, an external I/F (Interface) 1503, a RAM (Random Access Memory) 1504, a ROM (Read-Only Memory) 1505, a CPU (Central Processing Unit) 1506, a communication I/F (Interface) 1507, and a HDD (Hard Disk Drive) 1508, which are interconnected by a bus B.

The input device 1501 includes a keyboard, a mouse, and a touch panel, which are used by the user for inputting operation signals. The display device 1502 includes a display, etc., and displays processing results obtained by the computer system 1500.

The communication I/F 1507 is an interface for connecting the computer system 1500 to the networks N1 through N3. Accordingly, the computer system 1500 may perform data communications via the communication I/F 1507.

The HDD 1508 is a nonvolatile storage device storing programs and data. Examples of the stored programs and data are an OS (Operating System) which is the basic software for controlling the entire computer system 1500, and application software for providing various functions in the OS.

The HDD 1508 manages the stored programs and data by a predetermined file system and/or a DB (database). The external I/F 1503 is an interface between the computer system 1500 and an external device. An example of the external device is a recording medium 1503a. Accordingly, the computer system 1500 may read data from and/or write data in the recording medium 1503a via the external I/F 1503. Examples of the recording medium 1503a are a flexible disk, a CD (Compact Disk), a DVD (Digital Versatile Disk), an SD (Secure Digital) memory card, and a USB memory (Universal Serial Bus memory).

The ROM 1505 is a nonvolatile semiconductor memory (storage device) that may hold programs and data after the power is turned off. The ROM 1505 stores programs and data such as BIOS (Basic Input/Output System) that is executed when the computer system 1500 is activated, OS settings, and network settings. The RAM 1504 is a volatile semiconductor memory (storage device) for temporarily storing programs and data.

The CPU 1506 is a processor for loading the programs and data from storage devices such as the ROM 1505 and the HDD 1508 into the RAM 1504, and executing processes to control the entire computer system 1500 and realize its functions.

The client terminal 1011, the mobile terminal 1012, the access control device 1021, the print service providing device 1022, the scan service providing device 1023, and the other service providing device 1024 may realize various processes as described below, by the hardware configuration of the computer system 1500. Furthermore, the service providing device of the SaaS system, the service providing device of the common service system, and the storage device of the storage system may also realize various processes as described below, by the hardware configuration of the computer system 1500. Note that descriptions of hardware configurations of the image forming apparatus 1013 and the firewall FW illustrated in FIG. 1 are omitted.

### Software Configuration

### Service Providing System

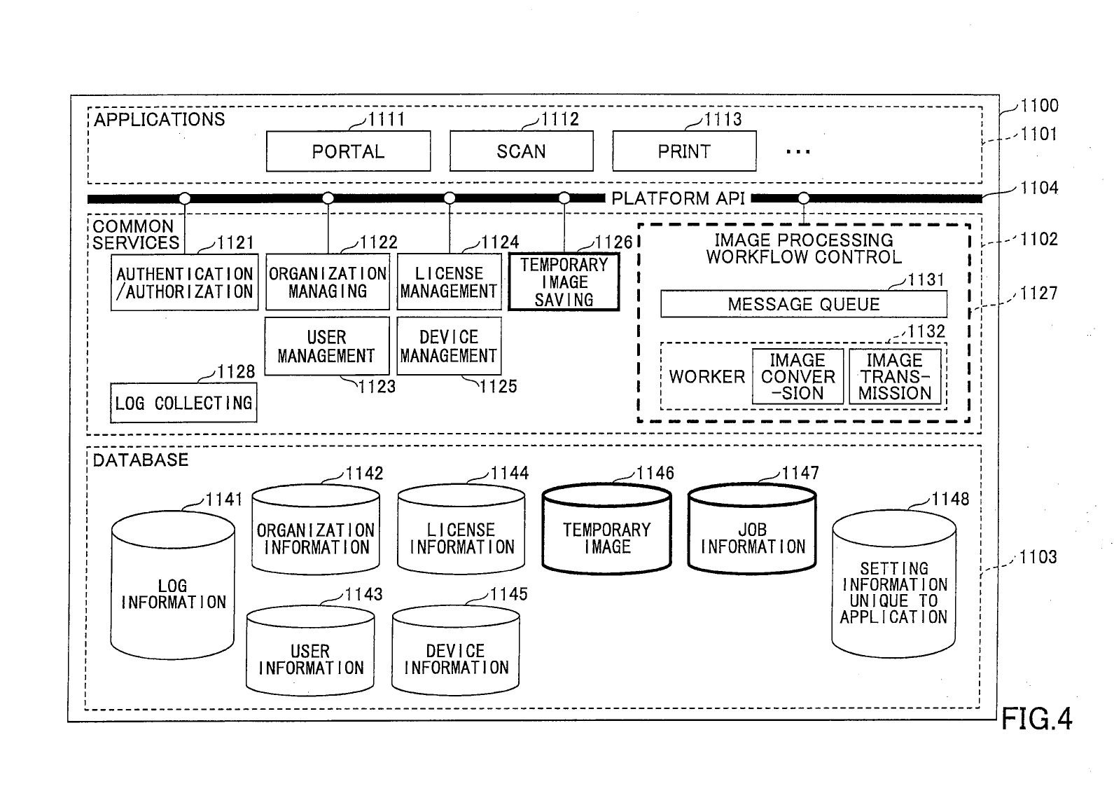

The service providing system according to the first embodiment is realized by, for example, process blocks as illustrated in FIG. 4. FIG. 4 is a process block diagram of an example of a service providing system according to the first embodiment.

A service providing system 1100 realizes applications 1101, common services 1102, a database (DB) 1103, and a platform API (Application Programming Interface) 1104, by executing programs.

The applications 1101 include, for example, a portal service application 1111, a scan service application 1112, and a print service application 1113.

The portal service application 1111 is an application for providing a portal service. A portal service provides a service acting as an entrance for using the service providing system 1100. The scan service application 1112 is an application for providing a scan service. The print service application 1113 is an application for providing a print application. The applications 1101 may include other service applications.

The platform API 1104 is an interface for using the common services 1102 by the applications 1101 such as the portal service application 1111, the scan service application 1112, and the print service application 1113. The platform API 1104 is an interface that is defined in advance, which is provided for the common services 1102 to receive requests from the applications 1101. The platform API 1104 is constituted by, for example, functions and classes.

The platform API 1104 is realized by, for example, a Web API that may be used via the network N3, when the service providing system 1100 is constituted by a plurality of information processing devices.

The common services 1102 include an authentication/authorization unit 1121, an organization managing unit 1122, a user management unit 1123, a license management unit 1124, a device management unit 1125, a temporary image saving unit 1126, an image processing workflow control unit 1127, and a log collecting unit 1128.

Furthermore, the image processing workflow control unit 1127 includes a message queue 1131 and at least one worker 1132. The worker 1132 realizes functions such as image conversion and image transmission.

The authentication/authorization unit 1121 executes authentication/authorization based on a login request from office devices such as the client terminal 1011 and the image forming apparatus 1013. The office device is a collective term of the client terminal 1011, the mobile terminal 1012, and the image forming apparatus 1013.

The authentication/authorization unit 1121 authenticates/authorizes a user by accessing, for example, a user information storage unit 1143 and a license information storage unit 1144, described below. Furthermore, the authentication/authorization unit 1121 authenticates, for example, the image forming apparatus 1013 by accessing, for example, the organization information storage unit 1142, the license information storage unit 1144, and the device information storage unit 1145, described below.

The organization managing unit 1122 manages organization information stored in an organization information storage unit 1142 described below. The user management unit 1123 manages user information stored in the user information storage unit 1143 described below.

The license management unit 1124 manages license information stored in the license information storage unit 1144 described below. The device management unit 1125 manages device information stored in a device information storage unit 1145 described below. The temporary image saving unit 1126 saves temporary images in a temporary image storage unit 1146 described below, and acquires temporary images from the temporary image storage unit 1146.

The image processing workflow control unit 1127 controls a workflow relevant to image processing, based on a request from the applications 1101. The message queue 1131 includes a queue corresponding to the kind of process. The image processing workflow control unit 1127 submits the message of the request relevant to the process (job), in the queue corresponding to the kind of the job.

The worker 1132 monitors the corresponding queue. When a message is submitted in the queue, the worker 1132 performs a process such as image conversion and image transmission according to the type of the corresponding job. Note that the submitted message may be subjectively read (pulled) by the worker 1132, or may be provided (pushed) from the queue to the worker 1132. Details of the process of the image processing workflow control unit 1127 are described later.

The DB (database) 1103 includes a log information storage unit 1141, an organization information storage unit 1142, a user information storage unit 1143, a license information storage unit 1144, a device information storage unit 1145, a temporary image storage unit 1146, a job information storage unit 1147, and a setting information storage unit 1148 unique to one of the applications 1101.

The log information storage unit 1141 stores log information. The organization information storage unit 1142 stores organization information described below. The user information storage unit 1143 stores user information described below. The license information storage unit 1144 stores license information described below. The device information storage unit 1145 stores device information described below.

The temporary image storage unit 1146 stores a temporary image. A temporary image is, for example, a file or data of a scanned image to be processed by the worker 1132. The job information storage unit 1147 stores information (job information) of a request relevant to a process (job). The setting information storage unit 1148 unique to an application stores setting information unique to one of the applications 1101.

The service providing system 1100 functions as an integrated base for providing a common service such as a workflow relevant to authentication/authorization and image processing, and a group of services providing application services, such as a scan service and a print service, by using the function of the integrated base. The integrated base is constituted by, for example, the common services 1102, the DB 1103, and the platform API 1104. The group of services is constituted by, for example, the applications 1101.

Note that the classification form of the process blocks of the service providing system 1100 illustrated in FIG. 4 is one example; it is not essential that the applications 1101, the common services 1102, and the DB 1103 are classified into a hierarchy as illustrated in FIG. 4. As long as the process of the service providing system 1100 according to the first embodiment may be performed, the hierarchical relationship illustrated in FIG. 4 is not limited to a particular relationship.

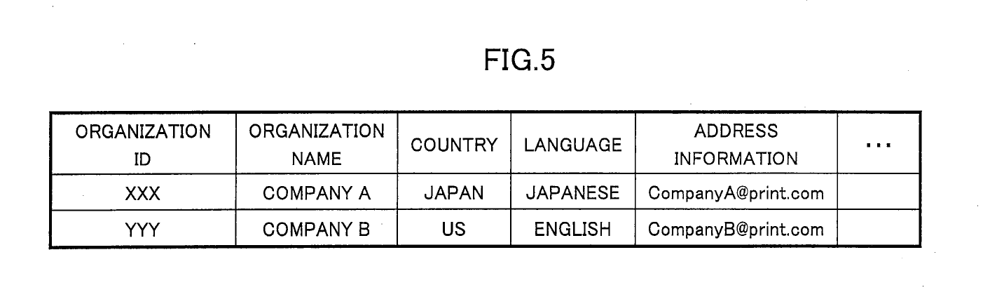

FIG. 5 is a configuration diagram of an example of organization information. The organization information includes, as data items, an organization ID, a country, a language, and address information. The organization ID is information for identifying a group such as a company and a department. The organization ID is not limited to the word “organization”; for example, the organization ID may be information for identifying a contract. Note that the organization ID is unique.

The organization name indicates the name of a group such as a company and a department. A country indicates a name of a country to which a group such as a company and a department belongs. The language indicates a language in use in a group such as a company and a department. The address information indicates a mail address of a group such as a company and a department.

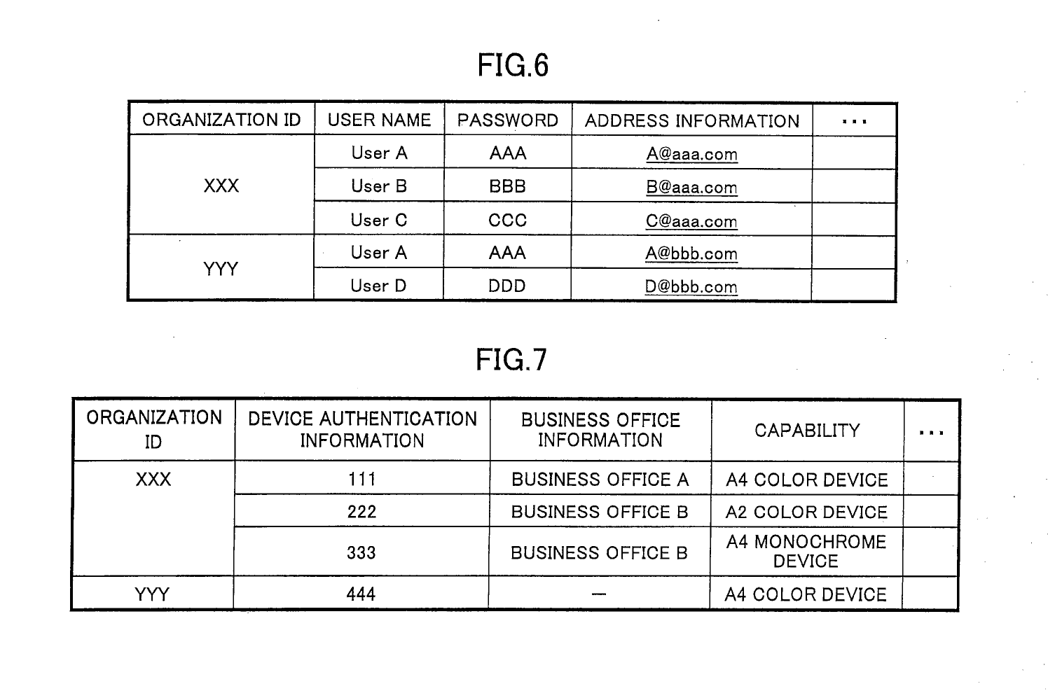

FIG. 6 is a configuration diagram of an example of user information. The user information of FIG. 6 includes, as data items, an organization ID, a user name, a password, and address information. The user name and the password are information for identifying a user. Hence, the user name may be a user ID, or the like. Furthermore, a password is not essential. Note that the user ID and password managed by the same organization ID are unique, but may overlap with another user ID and password if the organization ID is different. The address information indicates, for example, a mail address of a user.

Furthermore, as the user name, information for identifying an electronic medium (e.g., an IC card) held by the user may be used. As the electronic medium held by the user, an IC card, a mobile phone, a tablet terminal, and an electronic book terminal may be used. As the information for identifying an electronic medium, a card ID, a serial ID, a telephone number of a mobile phone, and profile information of a terminal may be used. The information for identifying an electronic medium may be used in combination.

FIG. 7 is a configuration diagram of an example of device information. The device information of FIG. 7 includes, as data items, an organization ID, device authentication information, business office information, and capability. The device authentication information is information used for device authentication, which is performed for determining whether an office device fulfills a particular condition. The device authentication information may be an ID indicating that a particular application is installed in the office device, or a device number indicating a particular office device. The business office information indicates, for example, the business office at which the office device is installed. The capability indicates, for example, the capability of the office device.

### Details of Process

### Save Scanned Image in Online Storage 1031

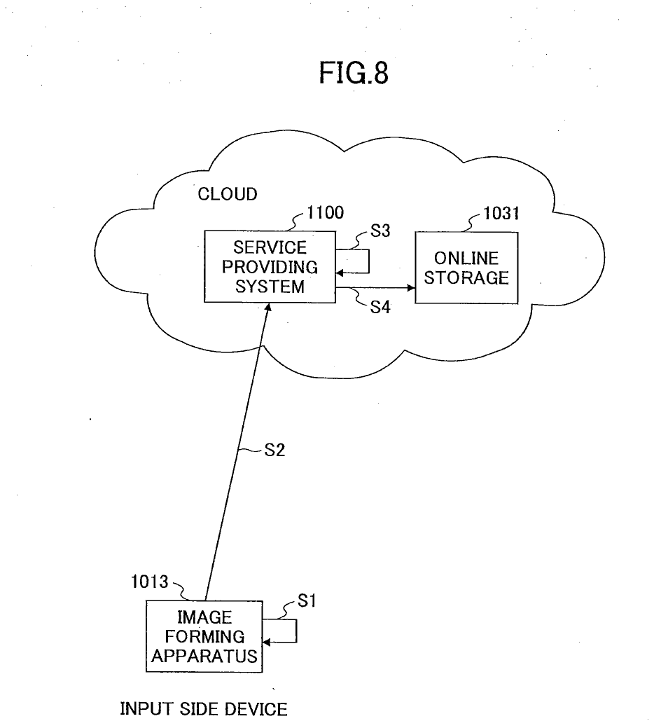

FIG. 8 is a schematic diagram depicting a process of saving a scanned image in online storage; note that the process depicted in FIG. 8 is initiated based on a request from a user who operates the image forming apparatus 1013.

In step S1, the image forming apparatus 1013 serving as an example an input side apparatus, for example, scans a document to create a scanned image (file). In step S2, the image forming apparatus 1013 uploads the created file to, for example, the service providing system 1100 in a cloud.

In step S3, the service providing system 1100 performs a process necessary for saving the uploaded file into the online storage. Note that details of the process of step S3 are described later. Then, in step S4, the service providing system 1100 saves in the online storage 1031 the file uploaded from the image forming apparatus 1013.

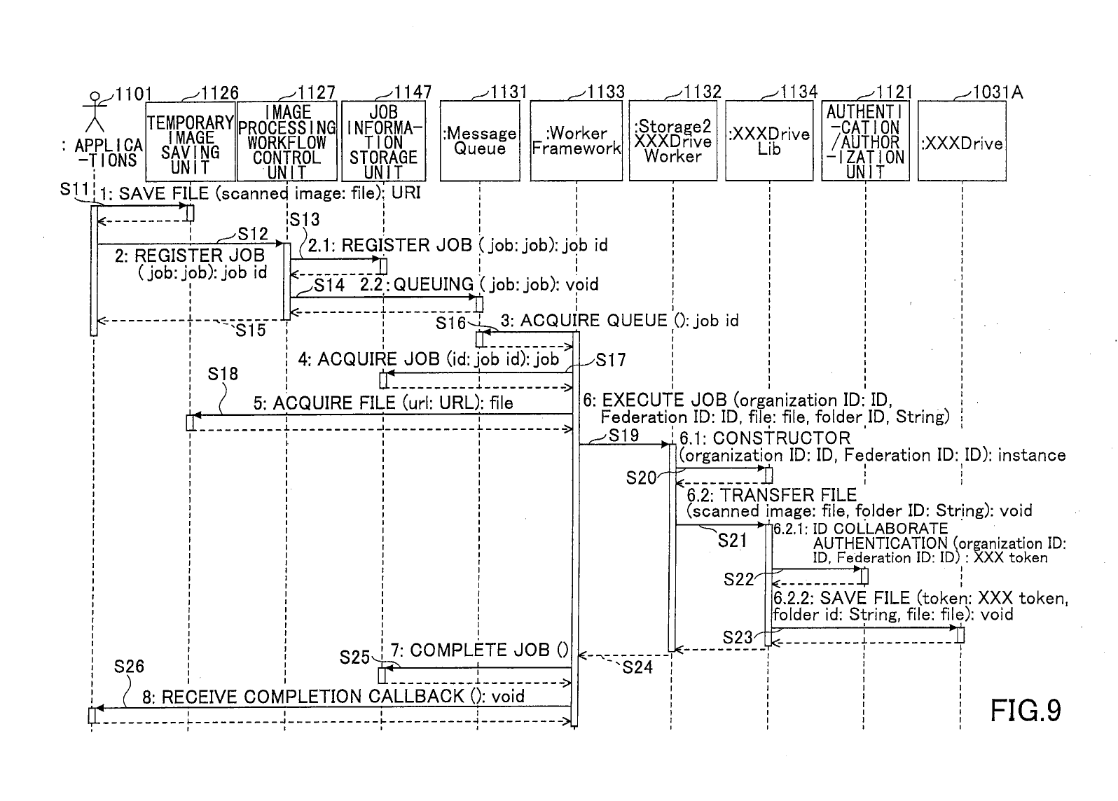

The process of saving the scanned image in the online storage 1031 illustrated in FIG. 8 may be performed as illustrated in a sequence diagram illustrated in FIG. 9.

FIG. 9 is a sequence diagram depicting an example of a process of saving a scanned image in the online storage. Note that the sequence diagram illustrated in FIG. 9 illustrates an example of a process after a file of the scanned image is uploaded from the image forming apparatus 1013 to the service providing system 1100.

In step S11, the scan service application 1112 serving as an example of applications 1101 requests the temporary image saving unit 1126 to save the file of the scanned image uploaded from the image forming apparatus 1013. The temporary image saving unit 1126 saves the file of the scanned image in the temporary image storage unit 1146, and returns to the scan service application 1112 a URI (Uniform Resource Identifier) indicating a location of the saved file.

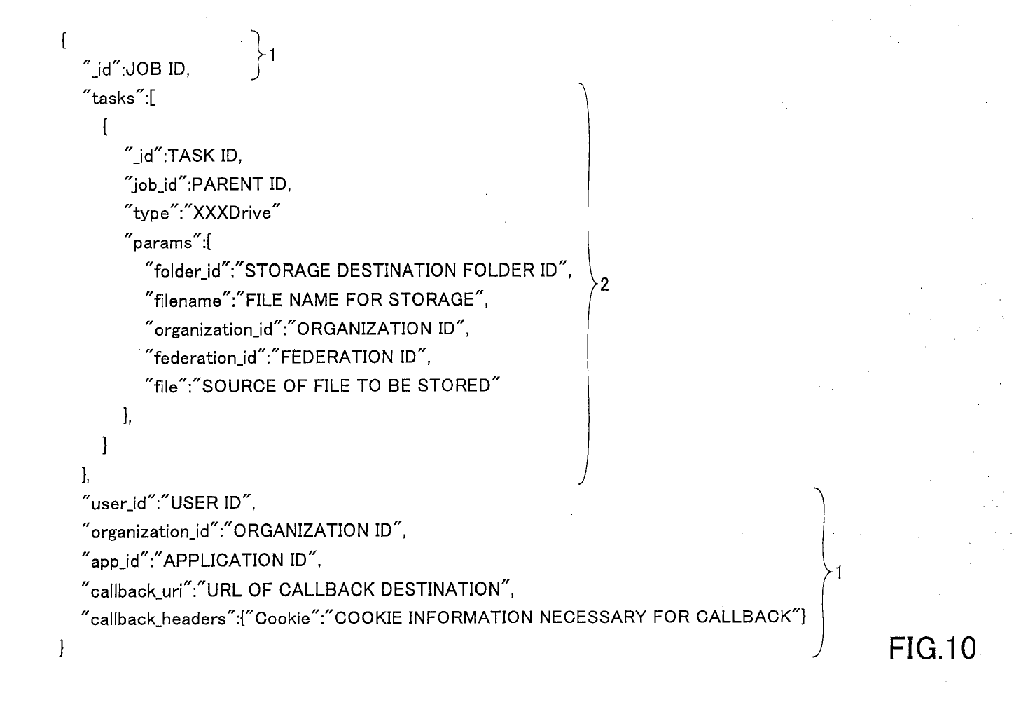

In step S12, the scan service application 1112 requests the image processing workflow control unit 1127 to register job information. Note that an example of the job information received from the scan service application 1112 may be illustrated in FIG. 10.

FIG. 10 is a configuration diagram of an example of job information. The job information of FIG. 10 includes a part 1 relating to a definition of a job, and a part 2 relating to a definition of a task. The part 1 relating to the definition of a job includes a job ID, a user ID, an organization ID, an application ID, a URL (Uniform Resource Locator) of a callback destination, and cookie information necessary for callback. The part 2 relating to the definition of a task includes a task ID, a parent ID, a type, and parameters (Params).

The job ID is information for identifying a job. The task ID is information for identifying a task. The parent job ID associates a task with a job, and is thus identical to the job ID of the part 1 relating to the definition of the job. Note that the job information received by the image processing workflow control unit 1127 includes respective voids in the job ID, the task ID, and the parent job ID.

The type indicates a type of a process performed by the worker 1132, which is set according to types (functions) of the process. FIG. 10 sets a process to save a file in an “xxxDrive” 1031A serving as an example of the online storage 1031.

The parameters (Params) are necessary for causing the worker 1132 to execute a process. In FIG. 10, a folder ID, a file name, an organization ID, a federation ID, and a file are set as the parameters necessary for executing the process to save a file in the online storage 1031A.

The folder ID indicates a folder to be saved. The file name indicates a name of the file used for saving the file. The organization ID and the federation ID are information for acquiring a later-described token for connecting to the “xxxDrive” 1031A from the authentication/authorization unit 1121. The file indicates information indicating a source of the file to be saved in the “xxxDrive” 1031A. For example, the file includes a setting of a URI indicating a location of the file of the scanned image saved in the temporary image storage unit 1146.

Note that the parameters may be set according to the type of the process performed by the worker 1132. The parameters (Params) may be unique to the type of the process performed by the worker 1132.

The user ID is information indicating a user who has requested execution of a job. The organization ID is information indicating an organization that has requested execution of a job. The application ID is information indicating one of the applications 1101 that has requested execution of a job. The URL of the callback destination is information indicating a destination to be called back. The cookie information necessary for the callback is used when the callback is applied to one of the applications 1101.

In step S13, the image processing workflow control unit 1127 registers job information of a job requested to be registered in the job information storage unit 1147. The job information storage unit 1147 issues a job ID of the job with the registered job information. Furthermore, the job information storage unit 1147 issues a task ID of a task included in the job of the registered job information. The job information storage unit 1147 adds the issued job ID and task ID to the job ID, the task ID and the parent job ID of the job information. Then, the job information storage unit 1147 returns the job ID of the job with the registered job information to the image processing workflow control unit 1127.

In step S14, the image processing workflow control unit 1127 analyzes a kind (a function) of a process based on the type included in the job information. The image processing workflow control unit 1127 submits a message of a request relating to the job in a queue of the message queue 1131 that matches the kind of the process. Note that the message of the request relating to the job includes the job ID. In step S15, the image processing workflow control unit 1127 returns the job ID of the registered job to the scan service application 1112 as a job registration result.

In step S16, a worker framework 1133 of the image processing workflow control unit 1127 that monitors the queue of the message queue 1131 detects the submission of the message of the request relating to the job. The worker framework 1133 then acquires the message registered in the queue.

In Step S17, the worker framework 1133 acquires from the job information storage unit 1147 the job information of the job ID included in the acquired message. In step S18, the worker framework 1133 reads the URI indicating the location of the file of the scanned image saved in the temporary image storage unit 1146 from the file included in the part 2 relating to the definition of the task of the acquired job information.

The worker framework 1133 then acquires the file of the scanned image from the temporary image storage unit 1146 by designating the URI indicating the location of the file of the scanned image saved in the temporary image storage unit 1146.

In step S19, the worker framework 1133 reads the type and the parameters (Params) included in the part 2 relating to the definition of the task of the acquired job. The worker framework 1133 analyzes a kind of the process based on the type.

The worker framework 1133 then instructs a “Storage2xxxDriveWorker” serving as an example of the worker 1132 to execute a job by designating the parameters (Params).

In step S20, the “Storage2xxxDriveWorker” serving as an example of the worker 1132 requests a xxxDrive library 1134 to generate an instance (constructor) by designating the organization ID and the federation ID included in the parameters (Params).

In step S21, the “Storage2xxxDriveWorker” serving as an example of the worker 1132 requests the instance of the xxxDrive library 1134 to transfer a file by designating the parameters (Params). The parameters designated in step 21 include a folder ID, a file name, and a file.

In step S22, the instance of the xxxDrive library 1134 requests the authentication/authorization unit 1121 to perform ID collaborate authentication by designating the organization ID and the federation ID. Note that the ID collaborate authentication indicates collaboration of authentication performed by the service providing system 1100 and authentication performed by the “xxxDrive” 1031A.

For example, when authentication information of the service providing system 1100 is associated with the authentication information of the “xxxDrive” 1031A and the associated information is stored, the authentication/authorization unit 1121 provides the xxxDrive library 1134 with a xxxtoken for connecting to the “xxxDrive” 1031A. Note that the authentication/authorization unit 1121 may be able to acquire the xxxtoken for connecting to the “xxxDrive” 1031A in advance by using authentication information (i.e., the organization ID and the federation ID) of the “xxxDrive” 1031A. The token is an example of authentication information. The token may be information that approves authentication.

In step S23, the xxxDrive library 1134 requests “xxxDrive” 1031A to save a file by designating the xxxtoken provided by the authentication/authorization unit 1121, and the folder ID, the file name, and the file set in the parameters (Params).

The result of saving the file in the “xxxDrive” 1031A is returned to the instance of the xxxDrive library 1134 from the “xxxDrive” 1031A. The result of saving the file is returned to the “Storage2xxxDriveWorker” serving as an example of the worker 1132 from the instance of the xxxDrive library 1134.

In step S24, the worker framework 1133 receives the result of saving the file from the “Storage2xxxDriveWorker” serving as an example of the worker 1132.

In step S25, the worker framework 1133 reports completion of the job to the job information storage unit 1147. The job information storage unit 1147 optionally updates status information of the completed job.

In step S26, the worker framework 1133 reads from the job information the URL of the callback destination included in the part 1 relating to the definition of the job, and reports the job completion to the callback destination. The sequence diagram of FIG. 9 illustrates an example in which the URL of the callback destination is the scan service application 1112.

Note that in a case where cookie information necessary for the callback is set in the part 1 of the job information relating to the definition of the job, the worker framework 1133 may be able to add the cookie information to the callback.

As described above, in the service providing system 1100 according to the first embodiment, after a job requiring a long process time is registered from the applications 1101 to the image processing workflow control unit 1127, the applications 1101 may be able to receive the report indicating the job completion. The applications 1101 may be able to quickly acknowledge the job completion that is performed asynchronously with registration.

In the service providing system 1100 according to the first embodiment, the job completion may be reported to the URL of the callback destination after the job completion, by setting the URL of the callback destination in the job information in advance. Furthermore, in the service providing system 1100 according to the first embodiment, the cookie information may appropriately be provided by setting the cookie information necessary for the callback in the job information in advance even when the cookie information (HTTP header) is required for performing the callback.

Note that the report of the job completion in step S26 includes a process result such as normal/error as a reporting content. The scan service application 1112 that has received the report of the job completion may report the job completion to the user via an email.

In the service providing system 1100 according to the first embodiment, the job completion may be reported to the applications 1101 by using any one of the workers 1132 by implementing a callback process for reporting the job completion in the worker framework 1133.

The service providing system 1100 according to the first embodiment includes a function to provide a message from the queue to the worker framework 1133, a function to acquire job information from the job information storage unit 1147, and a function to acquire a file from the temporary image saving unit 1126.

The service providing system 1100 according to the first embodiment further includes a function to instruct the worker 1132 to execute a job, and a function to instruct the worker 1132 to report the job completion to the job information storage unit 1147 and the applications 1101. As described above, in the service providing system 1100 according to the first embodiment, the workers 1132 may be prevented from having duplicated functions by providing a function commonly used by the workers 1132 in the worker framework 1133.

Another Example of Reporting Job Information and Job Completion

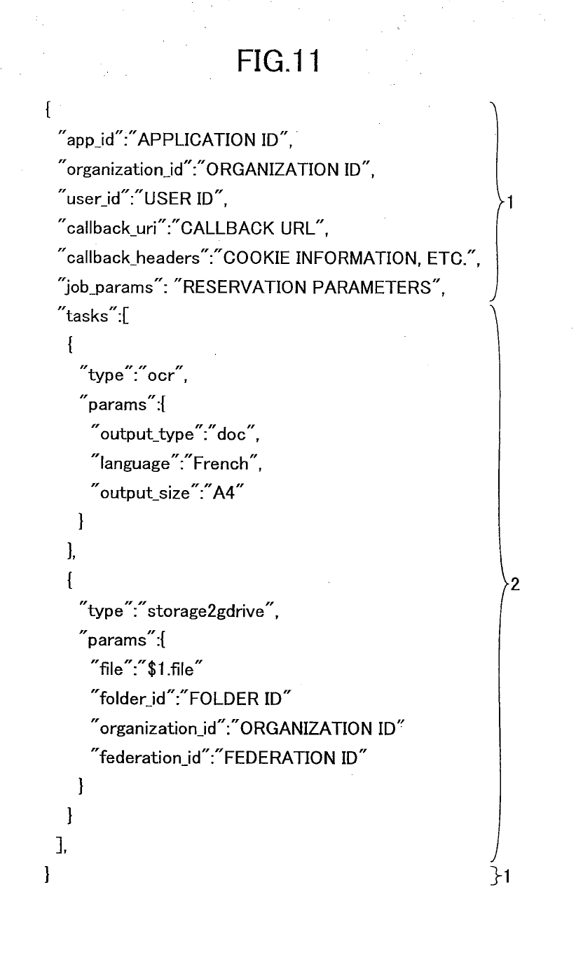

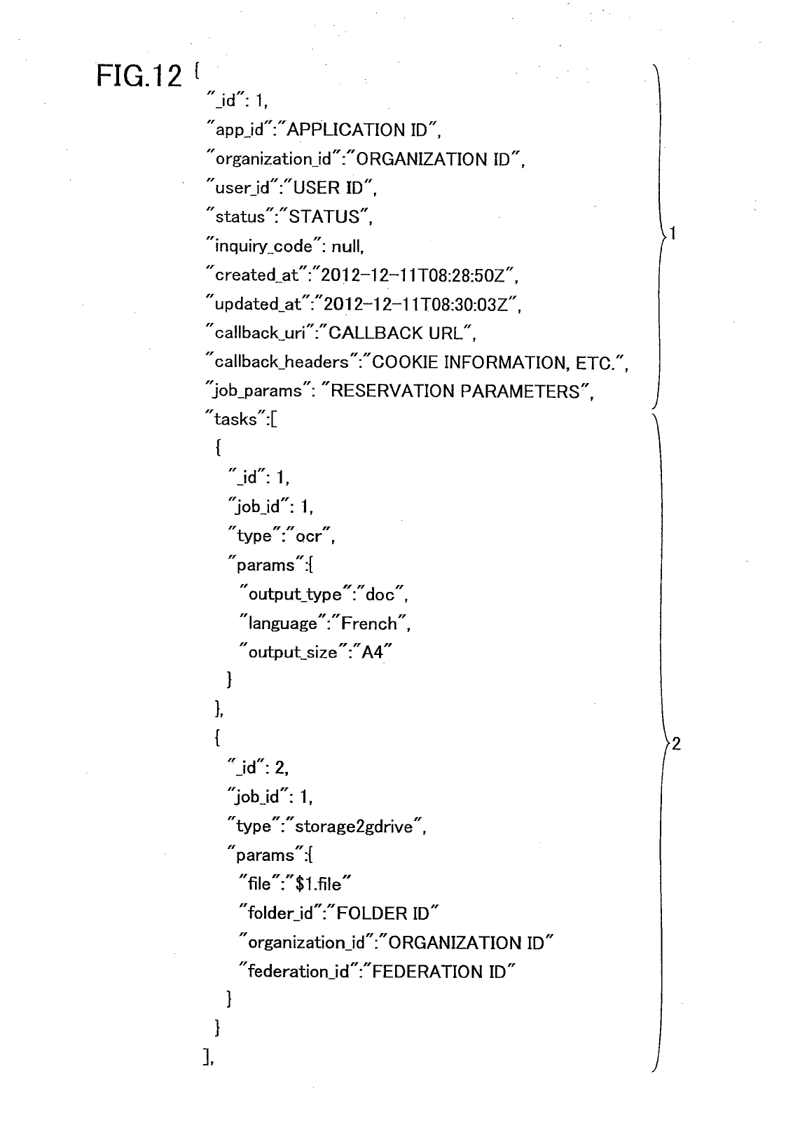

FIG. 11 is a configuration diagram of another example of the job information. The job information of FIG. 11 represents an example of executing an OCR (Optical Character Recognition) process with respect to a scanned image and storing the generated file in the online storage 1031. Note that FIG. 11 is an example of the job information received from the scan application 1112, from which the job ID, the task ID, and the parent job ID that include respective voids are omitted.

The job information of FIG. 11 includes a part 1 relating to a definition of a job, and a part 2 relating to a definition of a task in a manner similar to the job information of FIG. 10. The part 1 of the job information of FIG. 11 relating to the definition of the job is similar to the job information of FIG. 10, but further includes reservation parameters in order to optionally increase parameters in future.

Furthermore, the part 2 of the job information of FIG. 11 relating to the definition of the task is also similar to the job information of FIG. 10, but includes definitions of two tasks. The first task is an example of a process of executing an OCR with respect to the scanned image. The second task is an example of a process of saving the generated file in the online storage 1031.

The parameters (Params) included in the definition of the first task are unique to executing the OCR process with respect to the scanned image. The parameters unique to executing the OCR process with respect to the scanned image include a setting of a file format after the OCR process, a setting of a language for performing the OCR process, and a setting of an image (sheet) of the file after the OCR process.

The parameters (Params) included in the definition of the second task are unique to the process of saving the generated file in the online storage 1031. The parameters unique to the process of saving the generated file in the online storage 1031 include a setting of a URL indicating a location of the file to be stored in the online storage 1031. The example of FIG. 11 illustrates use of a result of the first task by setting $1 to the URL indicating a location of the file to be stored in the online storage 1031.

Furthermore, the parameters unique to the process of saving the generated file in the online storage 1031 include a setting of a folder for saving the file, and a setting for acquiring a token for connecting to the online storage 1031 from the authentication/authorization unit 1121.

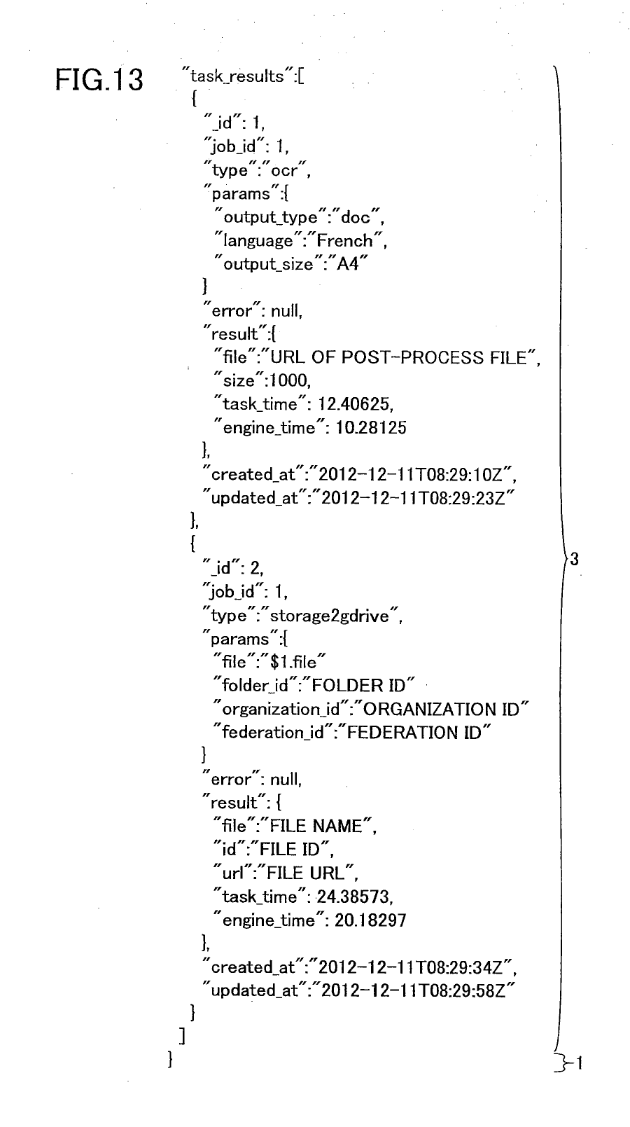

FIGS. 12 and 13 are configuration diagrams illustrating examples of reporting the job completion. The reporting of the job completion includes a part 1 relating to a definition of a job, a part 2 relating a definition of a task, and a part 3 relating to a definition of a result of the executed task. The part 1 relating to the definition of the job includes a job ID, an application ID, an organization ID, a user ID, a status, error information, job created date and time, job updated date and time, a URL of a callback destination, cookie information necessary for callback, and reservation parameters. The status indicates a status of a job, and includes settings of reception, in-process, completion, and error. When the status is “error”, information indicating a kind of error is set as error information.

The part 2 relating to the definition of the task includes the task ID and the parent ID added to the part 2 relating to the task of FIG. 11. The part 3 relating to the definition of the result of the executed task includes results of the executed two tasks that are defined in the part 2 relating to the definition of the task.

The definition of the result of the executed first task includes settings of error information, details of the process result, task process starting date and time, and task process completing date and time, in addition to the definition of the first task defined in the part 2 relating to the definition of the task of FIG. 12.

The details of the process result, for example, include a setting of a URL indicating a location of a post-process file, and a size of the post-process file, as a process result unique to the process of, for example, executing the OCR process with respect to the scanned image. Furthermore, the details of the process result include settings of time consumed for the entire task (the worker framework 1133 and the worker 1132), and time consumed for an engine (the worker 1132), as information commonly provided with respective functions.

The definition of the result of the executed second task includes settings of error information, details of the process result, task process starting date and time, and task process completing date and time, in addition to the definition of the second task defined in the part 2 relating to the definition of the task of FIG. 12. The details of the process result, for example, include settings of a name of the saved file, a file ID issued by the online storage 1031, and a URL indicating a location of the saved file, as a process result unique to the process of, for example, saving the generated file in the online storage 1031. Furthermore, the details of the process result include settings of time consumed for the entire task, and time consumed for an engine, as information commonly provided with respective functions, in a manner similar to the first task.

### Asynchronous Process

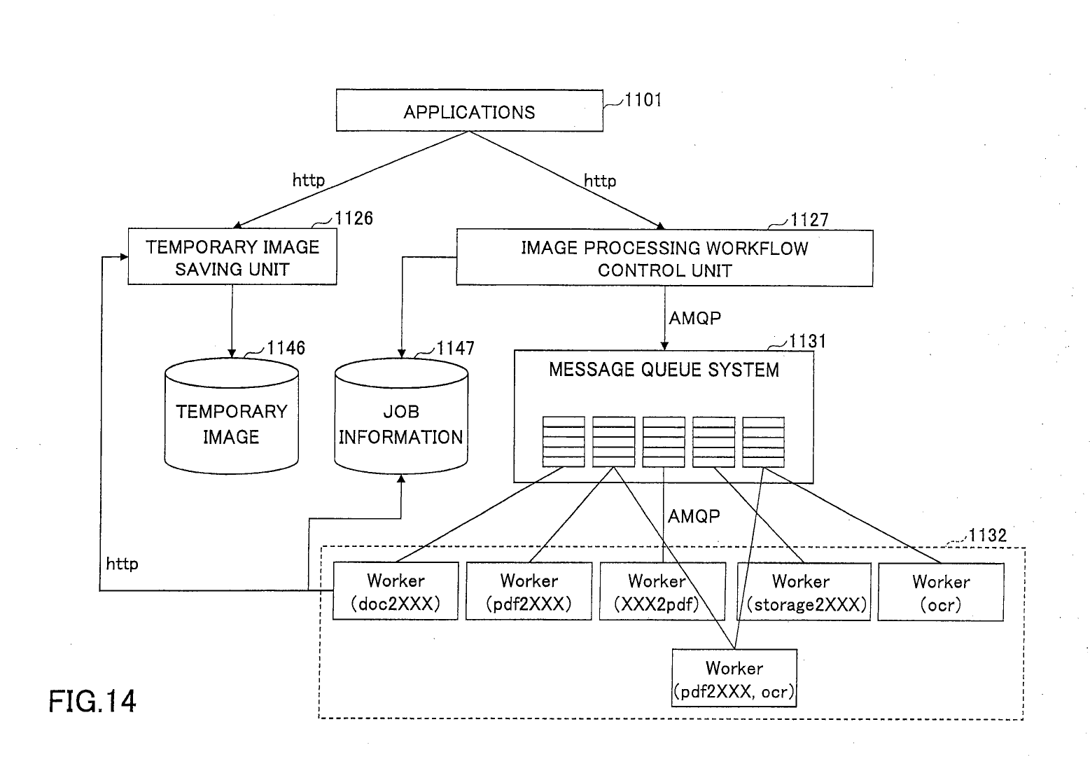

Illustration is given below of details of a flow of an asynchronous process by the service providing system 1100 illustrated in FIG. 4. FIG. 14 is a diagram illustrating an example of an asynchronous process by a service providing system.

FIG. 14 illustrates the applications 1101, the temporary image saving unit 1126, the image processing workflow control unit 1127, the message queue 1131, and the worker 1132 of the process block of the service providing system 1100 illustrated in FIG. 4.

The applications 1101 request the temporary image saving unit 1126 to temporarily store the file of the scanned image uploaded from the image forming apparatus 1013. The temporary image saving unit 1126 saves the file of the scanned image in the temporary image storage unit 1146, and returns to the scan service application 1112 a URI (Uniform Resource Identifier) indicating a location of the saved file. The applications 1101 request the image processing workflow control unit 1127 to register job information. The image processing workflow control unit 1127 registers the job information in the job information storage unit 1147. The job information storage unit 1147 issues a job ID of the job with the registered job information and returns the issued job ID to the image processing workflow control unit 1127.

The image processing workflow control unit 1127 analyzes a kind (a function) of a process based on a type included in the job information. The image processing workflow control unit 1127 submits a message of the request relating to the job in a queue of the message queue 1131 that matches the type of the process. The image processing workflow control unit 1127 analyzes a kind of the necessary process, and controls execution of an asynchronous process.

The message queue 1131 includes queues corresponding to two or more types of processes. FIG. 14 illustrates a relationship between the message queue 1131 and the worker 1132 that handles the queue by connecting a line between the two. As illustrated in FIG. 14, the worker 1132 may be able to handle one or plural queues. Furthermore, as illustrated in FIG. 14, a queue may be able to be handled by one or plural workers 1132.

For example, in FIG. 14, “doc2XXX”, “pdf2XXX”, “XXX2pdf”, “storage2XXX”, “ocr”, and “pdf2XXX.ocr” represent kinds of the processes handled by one worker 1132. The worker 1132 that handles the kind of the process represented by “pdf2XXX.ocr” is an example of the worker 1132 that handles plural kinds of processes.

The worker framework 1133 that monitors queues of the message queue 1131 detects a message of the request relating to the job that is submitted to the queue. The worker framework 1133 acquires the message registered in the queue. Illustration of the worker framework 1133 is omitted from FIG. 14. Details of the worker framework 1133 are described later.

The worker framework 1133 acquires from the job information storage unit 1147 the job information of the job ID included in the acquired message. The worker framework 1133 reads from the acquired job information a URI indicating a location of the file of the scanned image saved in the temporary image storage unit 1146.

The worker framework 1133 then acquires the file of the scanned image from the temporary image storage unit 1146 by designating the URL indicating the location of the file of the scanned image saved in the temporary image storage unit 1146.

The worker framework 1133 analyzes the kind of the process from the acquired job information, and instructs the worker 1132 having the matched kind of the process to execute a job. The worker 1132 that has executed the job returns a job execution result to the worker framework 1133.

The worker framework 1133 reports completion of the job (job completion) to the job information storage unit 1147. The job information storage unit 1147 optionally updates status information of the completed job. Furthermore, the worker framework 1133 reads the URL of the callback destination from the job information, and reports the job completion to the URL of the callback destination.

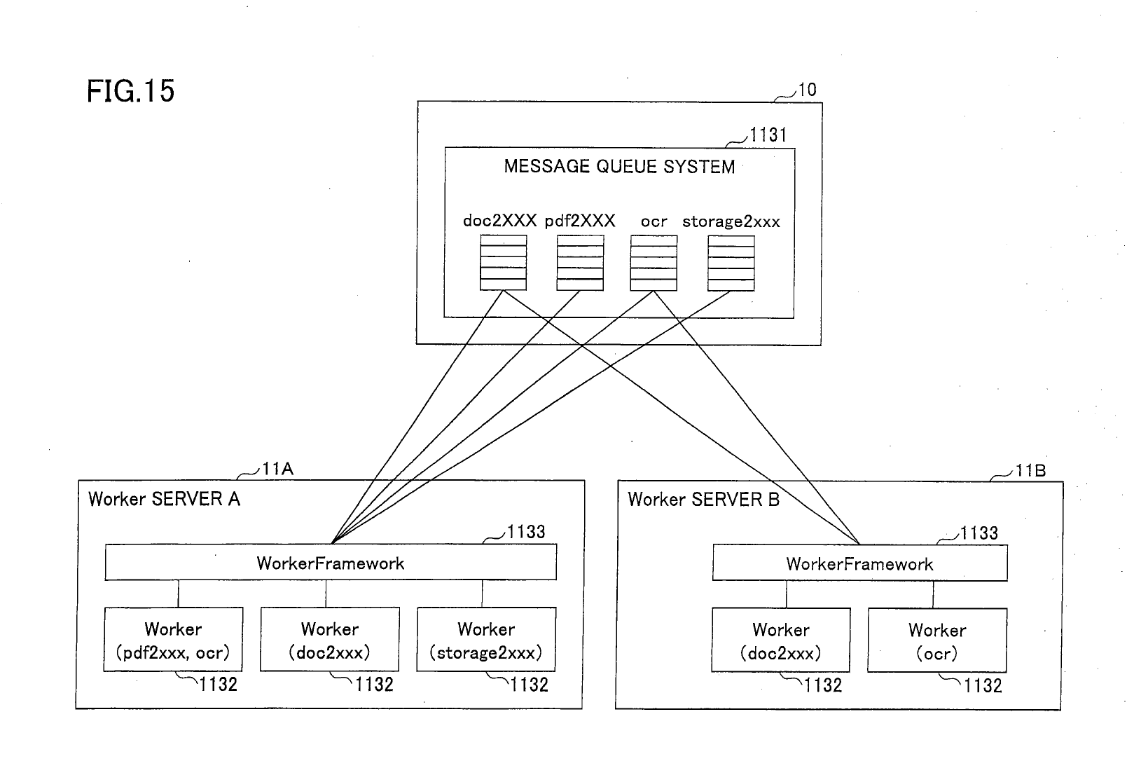

For example, a relationship between the message queue 1131, the worker 1132, and the worker framework 1133 may be represented by FIG. 15.

FIG. 15 is a diagram illustrating a relationship between a queue, and a worker, and a worker framework. The message queue 1131 includes plural queues. The queues are classified by the kinds (functions) of the processes. The message queue 1131 may operate, for example, on one server 10.

Furthermore, the worker 1132 and the worker framework 1133 operate on each of a worker server 11A and a worker server 11B. The worker server 11A and the worker server 11B may be implemented, for example, by a Windows (registered trademark) server or a Linux (registered trademark) server.

For example, when the worker servers 11A and 11B are Windows (registered trademark) servers, the worker servers 11A and 11B each cause two workers 1132 to operate. Furthermore, when the worker servers 11A and 11B are Linux (registered trademark) servers, the worker servers 11A and 11B each cause three workers 1132 to operate. As illustrated in FIG. 15, the worker framework 1133 and plural workers 1132 are disposed in each of the worker servers 11A and 11B.

As illustrated in FIG. 15, the worker framework 1133 may be able to poll plural queues by one connection. However, a range of the plural queues to be polled by one connection may be within a range of the workers 1132 that operate, for example, on an identical OS server.

Since there is a relationship illustrated in FIG. 15 between the queues of the message queue 1131, the workers 1132, and the worker framework 1133, the service providing system 1100 may be able to implement a process represented by the sequence diagram illustrated in FIG. 9.

### SUMMARY

In the service providing system 1100 according to the first embodiment, the completion of the process by the worker 1132 may be easily reported to the request source of the job in the asynchronous process employing the worker 1132 that requires a long time to complete.

The present invention is not limited to the embodiments specifically disclosed above, various alterations or modifications may be made without departing the spirit and the scope of the invention.

Note that the service providing system 1100 is an example of a network system. The worker 1132 is an example of an information processing program executing unit. The worker framework 1133 is an example of an execution control unit. The cookie information necessary for the callback is an example of information necessary for transmitting the completion of one or more processes to a reporting destination. The online storage 1031 is an example of a predetermined storage device. The token is an example of authentication information for connecting to a predetermined storage device. The reporting of the job completion is an example of a completion report.

According to the embodiments, it may be possible to easily report the completion of the process.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority or inferiority of the invention. Although the embodiments of the present invention have been described in detail, it should be understood that various changes, substitutions, and alterations could be made hereto without departing from the spirit and scope of the invention.

The present application is based on and claims the benefit of priority of Japanese Priority Patent Application No. 2013-021267, filed on Feb. 6, 2013, and Japanese Priority Patent Application No. 2014-007159, filed on Jan. 17, 2014, the entire contents of which are hereby incorporated herein by reference.

What is claimed is:

1. A network system including one or more information processing devices, the network system, comprising:
a plurality of information processing program executing units configured to execute different processes; and
an execution control unit configured
to cause, when receiving via a predefined interface, designation of one or more of the different processes and a reporting destination of a completion report indicating that the one or more of the different processes have been executed from an application installed on an external device connected to the network system via a network, one or more of the information processing program executing units to execute one or more of the different processes based on the designation of the one or more of the different processes, and
to transmit to the reporting destination, when the one or more of the different processes executed by the one or more of the information processing program executing units have been completed, a completion report indicating that the one or more of the different processes have been completed.

2. The network system as claimed in claim 1, wherein
the execution control unit transmits to the reporting destination the completion report indicating that the one or more of the different processes have been completed by adding necessary information to the completion report when transmitting the completion report to the reporting destination.

3. The network system as claimed in claim 1, wherein
the execution control unit transmits to the reporting destination the completion report indicating that the one or more of the different processes have been completed by including results of the one or more of the different processes in the completion report when transmitting the completion report to the reporting destination.

4. The network system as claimed in claim 3, wherein
when receiving from the execution control unit an instruction for executing one or more of the different processes based on the designation of the one or more of the different processes, the one or more of the information processing program executing units execute the one or more of the different processes based on the designation of the one or more of the different processes, and transmit results of the one or more of the different processes to the execution control unit.

5. The network system as claimed in claim 1, wherein
when receiving from the execution control unit an instruction to save a file in a predetermined storage device, as the instruction for executing one or more of the different processes based on the designation of the one or more of the different processes, the one or more of the information processing program executing units acquire authentication information for connecting to the predetermined storage device, and save the file in the predetermined storage device utilizing the acquired authentication information.

6. The network system as claimed in claim 1, wherein
the execution control unit causes the one or more of the information processing program executing units to collaborate with one another to execute the one or more of the different processes based on the designation of the one or more of the different processes.

7. An information reporting method executed by a network system, the network system including one or more information processing devices, the information reporting method, comprising:
receiving, by an execution control unit, from an application installed on an external device connected to the network system via a network designation of one or more processes and a reporting destination of a completion report indicating that the one or more processes have been executed via a predefined interface;
causing, by the execution control unit, one or more of information processing program executing units to execute one or more processes, based on the designation of the one or more processes, the one or more of information processing program executing units being configured to execute different processes; and
transmitting, by the execution control unit, to the reporting destination via the predetermined interface, a completion report indicating that the one or more processes have been completed when the one or more processes executed by the one or more of the information processing program executing units have been completed.
